(19) United States
(12) Patent Application Publication
(10) Pub. No.: US 2004/0156637 A1
(43) Pub. Date: Aug. 12, 2004

(54) Wavelength-division-multiplexing system with gain flattening device

(76) Inventors: Sun-Tae Jung, Anyang-shi (KR); Duk-Yong Choi, Anyang-shi (KR); Joo-Hoon Lee, Yongin-shi (KR); Dong-Su Kim, Anyang-shi (KR)

Correspondence Address: Steve S. Cha, Esq., CHA & REITER, 9TH FLOOR, 411 HACKENSACK AVE., HACKENSACK, NJ, 07601, US

(21) Appl. No.: 10/632,371

(22) Filed: Aug. 1, 2003

(30) Foreign Application Priority Data
Feb. 7, 2003 (KR) 2003-7707

(51) Int. Cl. H04J 14/02

(52) U.S. Cl. 398/82

(57) ABSTRACT

A wavelength-division-multiplexing system is disclosed and includes: a semiconductor-amplification section for amplifying each inputted channel with amplification factors corresponding to the compensation signals received therein; a multiplexer for multiplexing a plurality of channels inputted from the semiconductor-amplification section and outputting the multiplexed signals; an optical-detection section for splitting a part of the multiplexed optical signals inputted from the multiplexer, demultiplexing the split optical signals into a plurality of channels, converting each of the demultiplexed channels into corresponding electric signals, and outputting the electric signals; and, a control section calculating the pertinent intensity deviations by comparing each intensity of the electric signals inputted from the optical-detection section with a preset reference intensity and outputting compensation signals for compensating the intensity deviation of each channel to the semiconductor-amplification section.

### CLAIM OF PRIORITY

This application claims priority to an application entitled “Wavelength-division-multiplexing system with gain flattening device,” filed in the Korean Intellectual Property Office on Feb. 7, 2003 and assigned Serial No. 2003-7707, the contents of which are hereby incorporated by reference.

### BACKGROUND OF THE INVENTION

1. Field of the Invention

The present invention relates to a wavelength-division multiplexer/demultiplexer used in optical communication systems and, more particularly, to a wavelength-division-multiplexing system including a gain-flattening means.

2. Description of the Related Art

Recently, a demand for communication service is increasing rapidly in accordance with technology development and diffusion of various digital media, such as internet and satellite broadcasting. Time-division multiplexing (TDM), optical-time-division multiplexing (OTDM), and wavelength-division-multiplexing (WDM) techniques have been implemented to increase the transmission/reception speed of communication signals in today's environment.

The wavelength-division multiplexing is a method for transmitting and receiving simultaneously a plurality of channels having different wavelengths from one another, and it has different amplification levels according to the number of optical-signal channels used in an optical communication.

With the progress of the wavelength-division technology, especially with an increase in the available number of channels in the communication systems adopting the wavelength-division-multiplexing method, the possibility of operation error occurring increases according to the variation in the gain-flattening process. It is noted that in the field of optical communications, the gain flattening signifies the equalization of optical intensities of multiple channels having different wavelength bands, so as to adjust the optical intensities to be constant. That is, in the optical-communication field of wavelength-division multiplexing using a plurality of channels, an optical-intensity deviation among the channels multiplexed or demultiplexed generates a variation in the whole input/output optical intensity, and such a variation of the optical intensity causes an error in the actual number of channels used in optical communications. Therefore, in the wavelength-division-multiplexing scheme using a plurality of channels, the optical intensities must be controlled so as to be constant and must have minimal deviation of the optical intensities among channels.

In general, the communication system using the wavelength-division-multiplexing method comprises a wavelength-division multiplexer and a wavelength-division demultiplexer. The wavelength-division multiplexer may be constructed by utilizing a fiber grating, a thin film-type wavelength-division-multiplexing filter (WDM filter), an optical arrayed-waveguide Grating, etc.

FIG. 1 is a schematic view illustrating a wavelength-division-multiplexing system including a variable-optical attenuator according to the prior art. As shown in FIG. 1, the wavelength-division-multiplexing system includes a multiplexer 120 for multiplexing a plurality of channels having different wavelengths (λₗ˜λₙ) from one another, an optical-detection section 130 for detecting the optical intensities of the multiplexed optical signals, a control section 140 for compensating the optical-intensity deviation among each channel according to the optical intensities detected by the optical-detection section 130, and a variable-optical attenuator 110 for flattening the gain of each channel.

The multiplexer 120 is constructed utilizing an optical-arrayed-waveguide grating of a planar optical-waveguide-device type having input waveguides for the input of channels and an output waveguide for the output of multiplexed optical signals. The multiplexer 120 multiplexes the input channels into the corresponding optical signals, then outputs the multiplexed optical signals to the input of the optical-detection section 130.

The optical-detection section 130 comprises a tap 131, a demultiplexer 132 for demultiplexing the multiplexed optical signals, and a plurality of photo diodes 133 for converting each demultiplexed channel into an electric signal. The tap 131 splits the multiplexed optical signals inputted from the multiplexer 120, then inputs a part of split optical signals into the demultiplexer 132. The photo diodes 133 converts the intensity level of each demultiplexed channel into an electric signal and outputs the converted electric signals to the control section 140.

The control section 140 calculates the intensity deviation of the output from the optical-detection section 130 by comparing to a preset reference intensity, then outputs compensation signals in order to compensate the intensity deviation of each channel in the variable-optical attenuator 110.

The variable-optical attenuator 110 attenuates each optical intensity of channels showing a deviation from the preset reference intensity according to the compensation signals received from the control section 140. In this regard, according to the compensation signals from the control section 140, the variable-optical attenuator 110 controls the heat applied to each of the inputted channels, thereby attenuating the optical intensity of each channel to be set to the reference intensity.

As described above, the wavelength-division-multiplexing system uses the variable-optical attenuator 110 as a gain-flattening means for compensating the intensity deviation and the gain deviation of each channel, thus flattening the gain of each channel and possibly obtaining a stabilized transmission/reception of optical signals in an optical-communication network.

However, the above-mentioned wavelength-division-multiplexing system using a variable-optical attenuator compensator has some drawbacks in that the loss of optical intensity tends to be substantial. Also, because the variable-optical attenuator used in the conventional wavelength-division-multiplexing system is controlled using the temperature variation, it is not easy to integrate the variable-optical attenuator with an optical device, such as an optical-arrayed-waveguide grating. Further, it is not easy to reduce the volume and production cost of the planar-optical-waveguide device, which is used in the conventional system.

### SUMMARY OF THE INVENTION

Accordingly, the present invention has been made to solve the above-mentioned problems occurring in the prior art and provides additional advantages, by providing a wavelength-division-multiplexing system capable of minimizing the optical-intensity loss during the long-distant transmission of optical signals, by incorporating an amplification means in each channel.

According to a preferred embodiment, a wavelength-division-multiplexing system is provided and includes: a semiconductor-amplification section for amplifying each inputted channel with amplification factors corresponding to compensation signals; a multiplexer for multiplexing a plurality of channels inputted from the semiconductor-amplification section and outputting the multiplexed signals; an optical-detection section for splitting a part of the multiplexed optical signals inputted from the multiplexer, demultiplexing the split-optical signals into a plurality of channels, converting each of the demultiplexed channels to electric signals, and outputting the electric signals; and, a control section calculating the pertinent intensity deviations by comparing each intensity of the electric signals inputted from the optical-detection section with a preset reference intensity, then outputting compensation signals for compensating the intensity deviation of each channel to the semiconductor-amplification section.

### BRIEF DESCRIPTION OF THE DRAWINGS

FIG. 1 is a schematic view illustrating a wavelength-division-multiplexing system including a variable-optical attenuator according to the prior art;

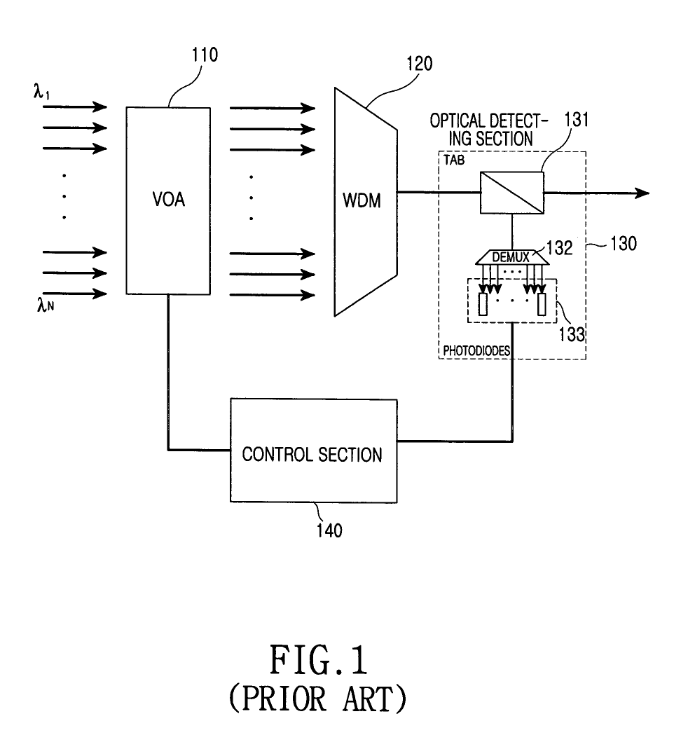

FIG. 2 is a schematic view illustrating a wavelength-division-multiplexing system including a semiconductor-amplification section as a gain-flattening means according to a first embodiment of the present invention; and,

FIG. 3 is a schematic view illustrating a wavelength-division-multiplexing system including an optical-detection section arranged between an amplification section and an optical-arrayed-waveguide grating according to a second embodiment of the present invention.

### DETAILED DESCRIPTION OF THE PREFERRED EMBODIMENT

Hereinafter, a wavelength-division-multiplexing system with a gain-flattening device according to preferred embodiments of the present invention will be described with reference to the accompanying drawings. For the purposes of clarity and simplicity, a detailed description of known functions and configurations incorporated herein will be omitted as it may make the subject matter of the present invention unclear.

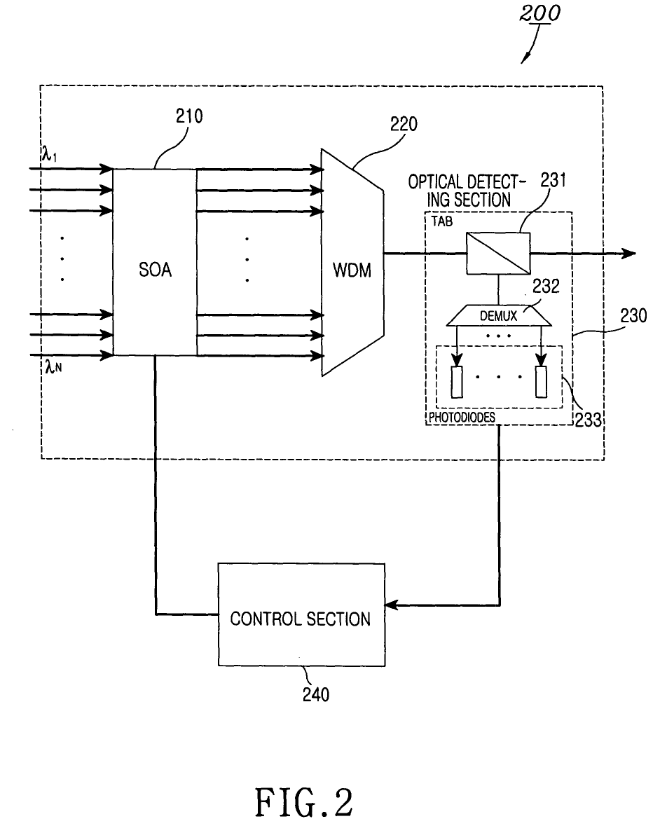

FIG. 2 illustrates a schematic view of a wavelength-division-multiplexing system including a semiconductor-amplification section as a gain-flattening device according to a first embodiment of the present invention. As shown in FIG. 2, the wavelength-division-multiplexing system comprises a semiconductor-amplification section 210 for amplifying each inputted channel, a multiplexer 220 for multiplexing each of the channels into optical signals, an optical-detection section 230 for demultiplexing optical signals into electric signals and for outputting the electric signals, and a control section 240 for compensating the intensity deviation of each channel in the semiconductor-amplification section 210.

In operation, the semiconductor-amplification section 210 amplifies each channel inputted from outside according to the amplification factors corresponding to the compensation signals of the control section 240, then inputs each of the amplified channels to the multiplexer 220. That is, the semiconductor-amplification section 210 amplifies the optical intensity of each channel showing a deviation from a preset reference intensity, so as to cause them to be set to the reference intensity. In essence, the semiconductor-amplification section 210 performs a function of flattening the gain of the optical intensity of each channel.

The multiplexer 220 is an device for outputting the channels gain-flattened and inputted from the semiconductor-amplification section 210 as a multiplexed optical signal. The multiplexer 220 may be constructed by utilizing an optical-arrayed-waveguide grating of the planar-optical-waveguide-device type, which has a plurality of input waveguides for the input path of each channel gain-flattened from the semiconductor-amplification section 210 and an output waveguide for the output path of the multiplexed optical signals. Also, the multiplexer 220 may be constructed by utilizing a multi-layer, thin-film type of WDM filter, a Fiber Grating forming a grating pattern, and so forth.

The optical-detection section 230 includes a tap 231, a demultiplexer 232 for demultiplexing the multiplexed optical signals, and a plurality of photo diodes 133 for detecting the intensity of each channel demultiplexed from the demultiplexer 232. That is, the optical-detection section 230 demultiplexes the multiplexed optical signals into each channel, converts the optical intensity of each of the channels into electric signals, and then outputs the electric signals to the control section 240.

The tap 231 splits the multiplexed optical signals inputted from the multiplexer 220, and inputs a part of the split optical signals into the demultiplexer 232. The demultiplexer 232 demultiplexes the multiplexed optical signals inputted from the tap 231 into a plurality of channels, then inputs the demultiplexed channels into the photo diodes 233 in a one-to-one correspondence. The photo diodes 233 converts the respective demultiplexed channels into corresponding electric signals and outputs the electric signals to the control section 240.

The control section 240 calculates the intensity deviation for each channel by comparing each intensity of the electric signals inputted from the optical-detection section 230 with a preset reference intensity, and then outputs compensation signals used for compensating the intensity deviation of each channel to the semiconductor-amplification section 210.

As described above, as the semiconductor-amplification section according to the present invention is utilized as a means for flattening the gain of the optical intensity of each channel, the optical-intensity loss of optical signals is minimized in the optical communication, thereby improving the transmission/reception efficiency of optical signals. That is, the wavelength-division-multiplexing system can minimize the loss of optical intensity by incorporating an amplification means for each channel to be set a preset reference value instead of the attenuation of such as in the prior art.

It is noted that the photo diodes 233 and the semiconductor-amplification section 210 may be constructed in an integrated optical circuit on the same semiconductor substrate, together with each driving circuit. Also, the multiplexer 220, the tap 231, and the demultiplexer 232 may be integrated on a substrate made from silica material, so as to form a planar-optical-waveguide device on the substrate. That is, the wavelength-division-multiplexing system according to the present invention may incorporate the integrated optical circuit and the planar-optical-waveguide devices in a Hybrid-Integration structure on the same platform 200.

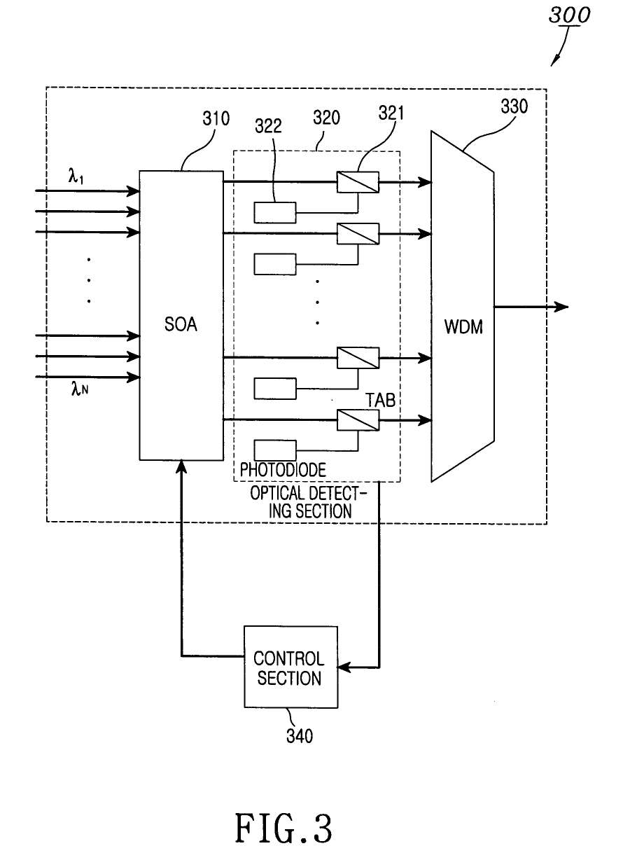

FIG. 3 is a schematic view illustrating a wavelength-division-multiplexing system according to a second embodiment of the present invention. As shown, the wavelength-division-multiplexing system includes a semiconductor-amplification section 310 for amplifying each channel, an optical-detection section 320 for converting a part of each channel to electric signals, a multiplexer 330 for multiplexing each channel into optical signals, and a control section 340 outputting compensation signals used for compensating the intensity deviation of each channel in the semiconductor-amplification section 310.

In operation, the semiconductor-amplification section 310 amplifies each channel inputted from the outside according to the amplification factors corresponding to the compensation signals received from the control section 340. That is, the semiconductor-amplification section 310 amplifies the optical intensity of each channel showing a deviation from a preset reference intensity to be set to the reference intensity according to the compensation signals inputted from the control section 340. As such, the function of gain flattening for each channel is achieved.

The optical-detection section 320 includes a plurality of taps 321 and a plurality of photo diodes 322. Each of the taps 321 splits the intensity of each of the channels inputted from the semiconductor-amplification section 310 and inputs the split channels into each pertinent photo diode 322. Each of the photo diodes is in a one-to-one correspondence with the channels and converts each of the channels to electric signals. That is, the optical-detection section 320 splits each channel inputted from the semiconductor-amplification section 310, outputs one part of each split channel to the control section 340 after converting each split channel to electric signals, and outputs the other part of each split channel to the multiplexer 330.

Thereafter, the multiplexer 330 multiplexes the channels inputted from the optical-detection section 320 and outputs the multiplexed optical signals. The multiplexer 330 is an optical-arrayed-waveguide-grating type of device including a plurality of input waveguides for the input of channels and an output waveguide for the output of the multiplexed optical signals.

The control section 340 calculates the pertinent intensity deviation by comparing the intensity of each of the electric signals inputted from the optical-detection section 320 with a preset reference intensity, then outputs compensation signals used for compensating the intensity deviation among each channel to the semiconductor-amplification section 310.

It is noted that the photo diodes 322 and the semiconductor-amplification section 310 may be constructed in an integrated optical circuit on the same semiconductor substrate, together with each driving circuit. The multiplexer 330 and the taps 321 may be integrated on a substrate made from silica material, so as to form a planar-optical-waveguide device on the substrate. That is, the wavelength-division-multiplexing system according to the present invention may incorporate the integrated optical circuit and the planar-optical-waveguide device in a Hybrid-Integration structure on the same platform 300. Further, the control section 340 may be additionally integrated on a semiconductor substrate on which the photo diodes 322 and the semiconductor-amplification section 310 are integrated.

It is noted that the gain-flattening means including the semiconductor-amplification section 310 of the present invention may be applied not only to a wavelength-division-multiplexing system as described above but also to a wavelength-division-demultiplexing system. In addition, the wavelength-division-multiplexing system using a semiconductor-amplification section as a gain-flattening means may be applied to a wavelength-division-demultiplexing system with the same structure. Furthermore, the wavelength-division-multiplexing system and the wavelength-division-demultiplexing system including a semiconductor-amplification section may be applied to a communication-network construction utilizing wavelength-division multiplexing/demultiplexing.

As described above, the present invention can minimize the loss of the optical intensity caused from a long-distant transmission because the semiconductor-amplification section is utilized as a gain-flattening means. Also, the present invention can improve the efficiency of network construction because the installation number of amplifiers is reduced in an optical-communication-network construction utilizing wavelength-division multiplexing/demultiplexing. Also, with the utilization of a semiconductor optical-amplification section, the photo diodes and the control section comprising an optical-detection section can be integrated on the same semiconductor substrate, so that it has advantages of reducing the volume and improving the integrated efficiency.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A wavelength-division-multiplexing system comprising:
a semiconductor-amplification section for amplifying input signals according to a compensation signal in order to compensate the intensity deviation of each channel in the semiconductor-amplification section;
a multiplexer for multiplexing a plurality of signal outputs from the semiconductor-amplification section;
an optical-detection section for splitting a part of the multiplexed optical signals from the multiplexer, for demultiplexing the split optical signals into a plurality of channels, and for converting each of the demultiplexed channels into corresponding electric signals; and,
a control section generating the compensation signal according to a comparison result of each converted electric signal to a predetermined reference intensity.

2. A wavelength-division-multiplexing system according to claim 1, wherein the optical-detection section comprises:
a tap for splitting the intensity of the multiplexed optical signal outputs from the multiplexer;
a demultiplexor for demultiplexing a part of the optical signals split from the tap into a plurality of channels; and,
a plurality of photo diodes, arranged in a one-to-one correspondence with the demultiplexed channels, for converting each of the channels to electric signals.

3. A wavelength-division-multiplexing system according to claim 1, wherein the multiplexer is made of a multi-layer, thin-film type of WDM filter.

4. A wavelength-division-multiplexing system according to claim 1, wherein the multiplexer is made of a Fiber Grating.

5. A wavelength-division-multiplexing system according to claim 2, wherein the multiplexer, the tap, and the demultiplexer is integrated on a substrate made from silica material.

6. A wavelength-division-multiplexing system comprising:
a semiconductor-amplification section for amplifying input signal according to a compensation signal;
an optical-detection section for splitting each of the channel outputs from the semiconductor-amplification section and for converting a part of each split-channel output into corresponding electric signals;
a multiplexer for multiplexing each of the channel outputs from the optical-detection section into corresponding optical signals; and,
a control section for the compensation signal based on a comparison result of each intensity of the output signals from the optical-detection section to a predetermined reference intensity.

7. A wavelength-division-multiplexing system according to claim 6, wherein the optical-detection section comprises:
a plurality of taps for splitting each channel outputs from the semiconductor-amplification section, for outputting one part of each split-channel output to a corresponding photo diode, and for outputting the other part of each split-channel output to the multiplexer; and,
a plurality of photo diodes, arranged in a one-to-one correspondence with each channel output, for converting each of the channel outputs into corresponding electric signals.

8. A wavelength-division-multiplexing system according to claim 6, wherein the multiplexer is made of a multi-layer, thin-film type of WDM filter.

9. A wavelength-division-multiplexing system according to claim 6, wherein the multiplexer is made of a Fiber Grating.

10. A wavelength-division-multiplexing system according to claim 7, wherein the multiplexer, the tap, and the demultiplexer is integrated on a substrate made from silica material.
